(19) United States
(12) Patent Application Publication
(10) Pub. No.: US 2005/0078922 A1
(43) Pub. Date: Apr. 14, 2005

(54) Electrical cable with temperature sensing means and method of manufacture

(76) Inventors: Eugene Turner Sanders, Carrollton, GA (US); Steven Ray Campbell, Carrollton, GA (US); Allan Wayne Daniel, Woodland, AL (US); John Nicholas Ware JR., Villa Rica, GA (US); Jason Miles Baker, Pell City, AL (US); William McDowell Berry III, Newnan, GA (US)

Correspondence Address: SMITH, GAMBRELL & RUSSELL, LLP;SUITE 3100, PROMENADE II, 1230 PEACHTREE STREET, N.E., ATLANTA, GA, 30309-3592, US

(21) Appl. No.: 10/622,040

(22) Filed: Jul. 17, 2003

Related U.S. Application Data
(60) Provisional application No. 60/396,853, filed on Jul. 18, 2002.

(51) Int. Cl. G02B 6/44

(52) U.S. Cl. 385/101

(57) ABSTRACT

An electrical cable having a holding member arranged longitudinally along the cable for an optic fiber, which can be used for temperature sensing and/or communications. The holding member can replace one or more strands of the cable, be placed inside an interstice of the cable, be placed in between various layers of the cable, or placed in the jacket of the cable. The cable can be produced through the addition of a planetary strander device to a wire assembly apparatus.

### CROSS-REFERENCE TO RELATED APPLICATIONS

This application claims priority to provisional patent application Ser. No. 60/396,853, which is relied on and incorporated herein by reference

### BACKGROUND OF THE INVENTION

The present invention relates to an electrical cable with a temperature sensing means, and more specifically, to an electric cable that utilizes an optic fiber temperature sensing means placed longitudinally in the cable. It is desirable to accurately measure the temperature of a cable because the amount of electrical current that can be carried by a cable is limited by temperature. With accurate information regarding cable temperature, utility companies can make better use of their infrastructure.

It is relatively easy to estimate the temperature of a known conductor cable in a steady state ambient air temperature. In contrast, it is extremely difficult to determine the temperature of a cable under real world operating conditions due to the influence of wind, rain, solar radiation, and ever changing ambient air temperatures.

Conventional methods for measuring cable/conductor temperatures include Valley Group CAT-1 Tension Monitor, the EPRI Video Sagometer, and the USI donut. The CAT-1 method measures cable tension and weather conditions and the calculates the expected cable temperature using a thermal model. The EPRI Video Sagometer measures the cable sag and then calculates the expected cable temperature using a thermal elongation model. The USI donut uses two thermocouples placed on the outside surface of the transmission cable to measure its temperature at a single point. None of these methods measure the internal temperature of the cable/conductor or give real time temperature data for the length of the cable. Furthermore, they fail to satisfactorily measure cable temperature axially and radially throughout the entire length of the cable as can be obtained by the present invention.

The following U.S. patents describe temperature sensing with fiber optics and/or detail cables having optic fibers and electrical conductors.

U.S. Pat. No. 5,696,863 details fiber optic methods and devices for sensing physical parameters, like temperature or force.

U.S. Pat. No. 5,991,479 details distributed fiber optic sensors to measure temperature at different points along the fiber.

U.S. Pat. No. 4,852,965 details a composite optical fiber-copper conductor, which includes one or more reinforced optical fiber units and one or more metallic conductor pairs enclosed in a sheath system.

U.S. Pat. No. 4,952,020 details a ribbon cable having optical fibers and electrical conductors spaced side to side within a flexible jacket.,

U.S. Pat. No. 5,029,974 details a gel-filled plastic buffer tube for carrying optical fibers.

U.S. Pat. No. 5,651,081 details a composite fiber optic and electrical cable having a core which loosely contains at least one optical fiber, one or more electrical conductors having an outer polymer insulating layer, one or more strength members, and a surrounding protective jacket.

U.S. Pat. Nos. 5,917,977 and 6,049,647 detail a composite cable having a conductor and at least one fiber optic conductor in the core.

U.S. Pat. No. 6,072,928 relates to a tow cable for measuring temperature in a water column having a fiber optic core, an electrically conducting polymer jacket, and a temperature sensor embedded in the polymer jacket.

U.S. Pat. No. 6,236,789 details a composite cable for access networks having one or more buffer tubes, each buffer tube encircling at least two optical fibers for supplying optical signals to at least two of the units, each unit having electrical current and voltage requirements. The cable has a layer of S-Z stranded electrically insulated conductors around the buffer tube or tubes. The number of pairs of conductors is less than the number of active optical fibers which excludes conductor spares. Preferably, the buffer tubes are S-Z stranded. The cable also includes a strength member and an outer plastic jacket encircling the buffer tubes, the conductors and the strength member.

### SUMMARY OF THE INVENTION

The present invention comprises an electrical conductor/cable having a holding member or a protective tube for optic fibers. The holding member can contain one or more optic fibers.

The holding member can be located in the interstices of the stranded cable or replace a strand of the cable. The holding member can be located in an interstice formed by the reinforcing strands and/or the conductive strands because the holding member has a diameter smaller than the size of an interstice. More than one holding member can be stranded into one or more interstices of the cable. The member can be placed in the cable in a longitudinal fashion or a helical wrap around the inner insulated cable. Alternatively, the holding member can replace a reinforcing strand and/or a conductive strand in the cable.

The holding member can be made so that it includes an optic fiber or it can be placed into the cable without an optic fiber. If an optic fiber is present, it can be used for temperature monitoring and/or communications. An optic fiber inside the a holding member could be used for similar or different functions when compared to another optical fiber that may be protected by the same or different holding member.

To determine temperature, an optic fiber could be used to accurately determine real-time thermal operating limits. For example, the optic fiber could be used to determine thermal properties of an overhead transmission line axially throughout the entire length of the line using distributed temperature sensing.

The holding member can be placed in a variety of electrical cables and should be resistant to crushing because the optic fiber within may be damaged and rendered useless if the member is crushed. Furthermore, it is also advantageous to distribute the pressure placed on the inner insulated conductor from such a member. Distribution of pressure results in less indentation of the outer layer of the insulation of the core conductor by the member, which would be to the advantage of maintaining the integrity of the insulation.

To achieve resistance to crushing and distribute pressure, the fiber holding member has an oval outer periphery. The member can be made completely of stainless steel or a combination of stainless steel and dielectric type plastic. The member can be made in several configurations to have void areas in which to locate optic fibers, gel, and the like.

To avoid twisting an optical fiber contained in a holding member, the holding member can be placed longitudinally in the jacket material. The holding member is placed in this position during the process of placing the jacket onto a cable with either a core/neutral wire assembly or core/welded armor assembly. The holding member is longitudinally placed on the core assembly then the plastic jacket is extruded on this assembly effectively embedding the member into the jacket.

The holding member could alternatively be added to the neutral layer or substituted for a neutral strand. The holding member would have the same spiraling position along the cable as the neutrals. The application of the holding member in the same position as the neutrals requires a planetary strander to keep from introducing a twist to the holding member and the fiber contained within. By placing the holding member onto the cable longitudinally the holding member containing the fiber is not twisted.

Other ways to avoid twisting include placing the holding member longitudinally between the core and the bed tape of the cable, or placing the holding member longitudinally between the neutral strand layer and the water swellable tape.

The holding member can be stranded into electrical cables by a device placed on the up-stream side of the flyer placing the layer that the tube(s) need to go under, into or on top of. The device would be a planetary type strander designed to hold the number of the holding members that need to be placed in the cable.

For placing the members under the layer of the strands, the device would have a signal generator that rotates the device's planetary flyer in unison with the spiral configuration of the pre-stranded core passing through the device. This could be done by sensing the passage of the core and counting the passage of strands, human input to the device would tell it how many strands were in the outer layer of the core thus generating a signal to rotate the planetary flyer in unison with the lay of the outer layer of the core. If the core passing through was not pre-stranded and is being stranded by a up-stream flyer of the rigid frame strander from the device, then the device could sense the rotation of the up-stream flyer and rotate the planetary flyer in unison with the up-stream flyer placing members on top of the core making them end up under the strands of the down-stream flyer.

For placing the holding member into or on top of the layer of down-stream flyer the device would have a signal generator that rotates the device's planetary flyer in unison with the rotation of the down-stream flyer placing the tube(s) on the same spiral lay as the layer being placed by the down-stream flyer.

Alternatively, the fiber optic member can be stranded into an electrical cable by a device placed between the flyer and the closing block holder of the strander so that the holding member goes into or into the interstices of that layer. The device would be a planetary type strander designed to hold the number of fiber containing protective tubes that need to be placed in the particular layer of the cable.

For placing the fiber optic member into a layer or into the interstices of the strands of a layer the device would have a signal sensing drive or direct mechanical drive that rotates the device's planetary flyer in unison with the flyer of the layer that device is applying the tube(s) in or on to. The fiber optic member would share a common closing block with the strands coming from the rigid frame flyer that the device is placed in.

### BRIEF DESCRIPTION OF THE DRAWINGS

FIG. 1a is a schematic cross section of a core of an electrical cable having a holding member in an interstice according to the present invention.

FIG. 1b is a schematic cross section of the present invention having several holding members located in various interstices.

FIG. 1c is a schematic cross section of the present invention having a holding member replace a conducting strand.

FIG. 1d is a cross section of the present invention wherein the holding member replaces a reinforcing strand near the center of the core.

FIG. 1e is a cross section of the present invention wherein the holding member replaces a reinforcing strand near the outer periphery of the core.

FIG. 1f depicts another cross section of a core where the holding member replaces one of the conducting strands.

FIG. 2a depicts a cross section of a welded corrugate armor shield type high voltage cable having a holding member located in between a layer of tape and corrugated welded armor.

FIG. 2b depicts a partial cross section of the aforementioned embodiment.

FIG. 2c depicts an embodiment of the cable having two holding members.

FIG. 2d depicts an embodiment of the cable having three holding members.

FIG. 2e depicts an embodiment of the cable having four holding members.

FIG. 3a depicts a variety of configurations associated with the holding member of the present invention.

FIG. 3b depicts further configuration varieties for the holding member of the present invention.

FIG. 4 is a cross section of a cable where the holding member is placed in the jacket material.

FIG. 5 is a cross section of a cable where stranded neutrals and the holding member are embedded in the jacket material.

FIG. 6 is a cross section of a cable where the holding member is placed in between the core and the layer of tape.

FIG. 7 is a cross section of a cable where the holding member replaces a stranded neutral.

FIG. 8a is a schematic of a wire assembly apparatus to make the present invention with prestranded core

FIG. 8b is a schematic of a wire assembly apparatus to make the present invention.

FIG. 8c is a schematic of a different wire assembly apparatus to make the present invention.

FIG. 8d is a schematic of another embodiment of a wire assembly to make the present invention.

### DETAILED DESCRIPTION

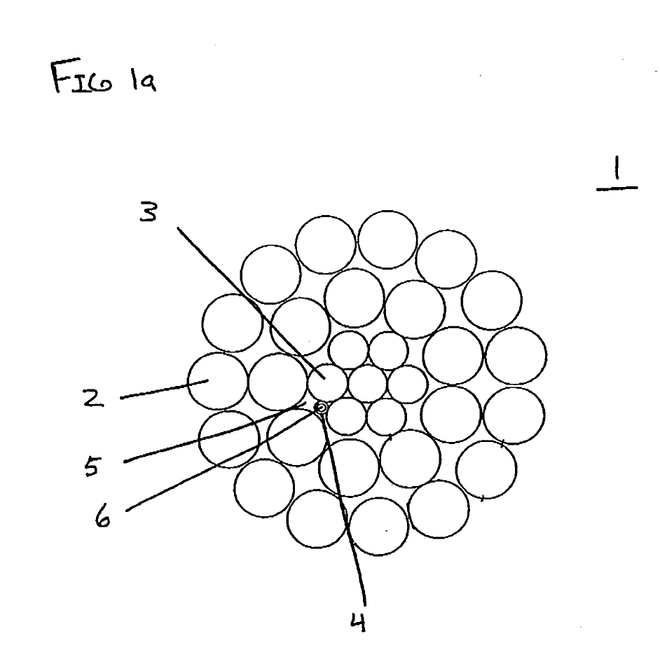

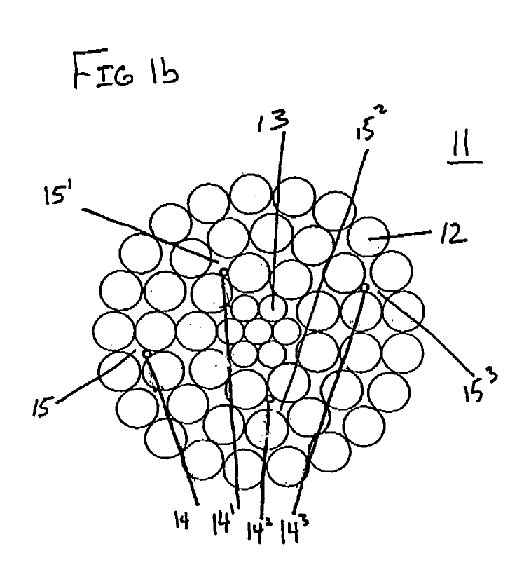

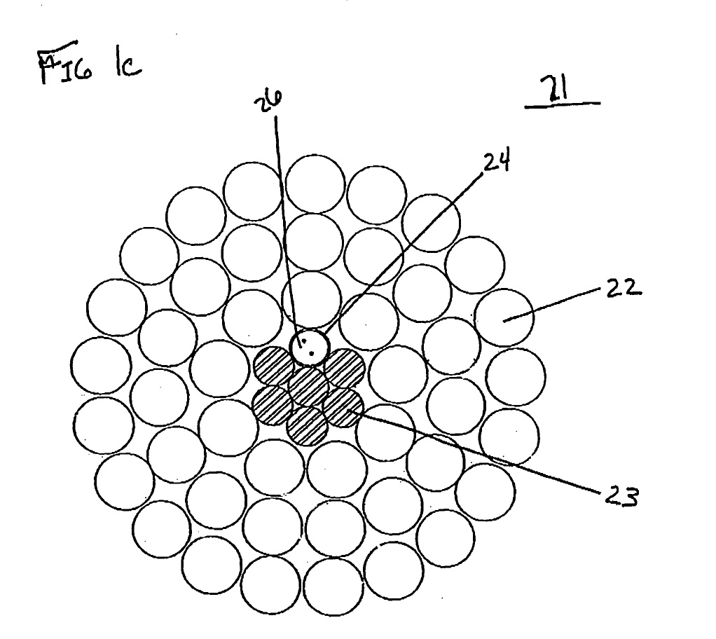

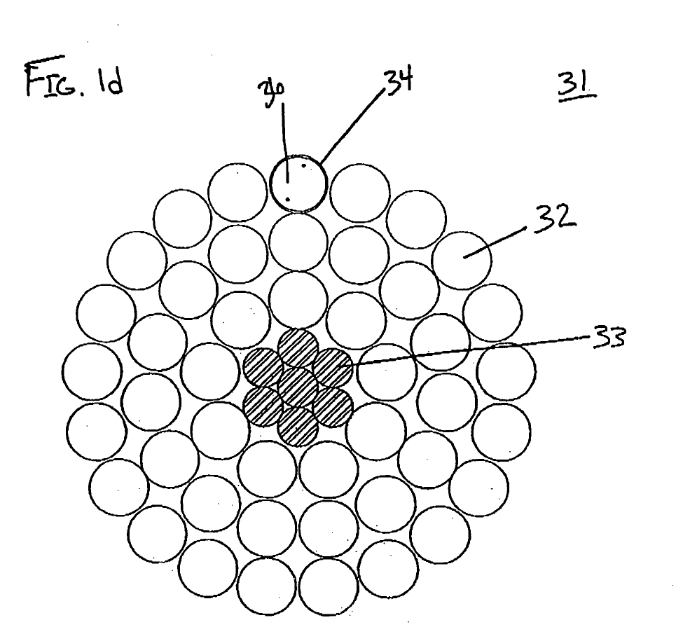

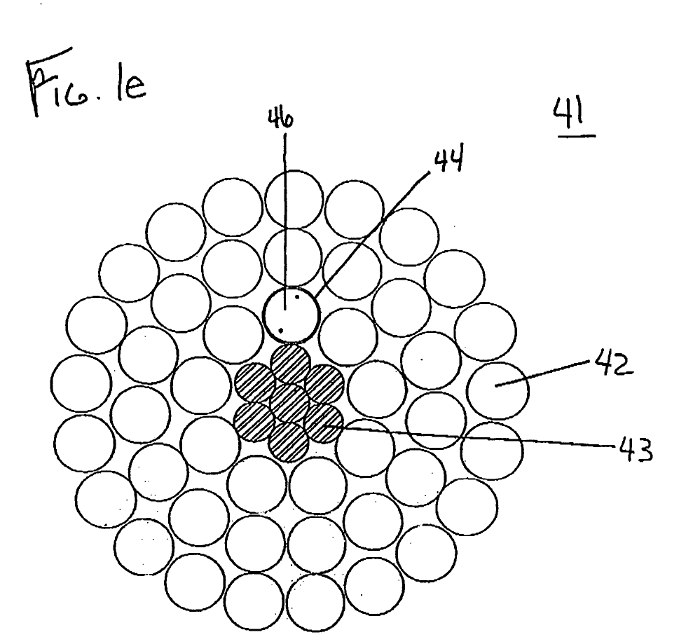

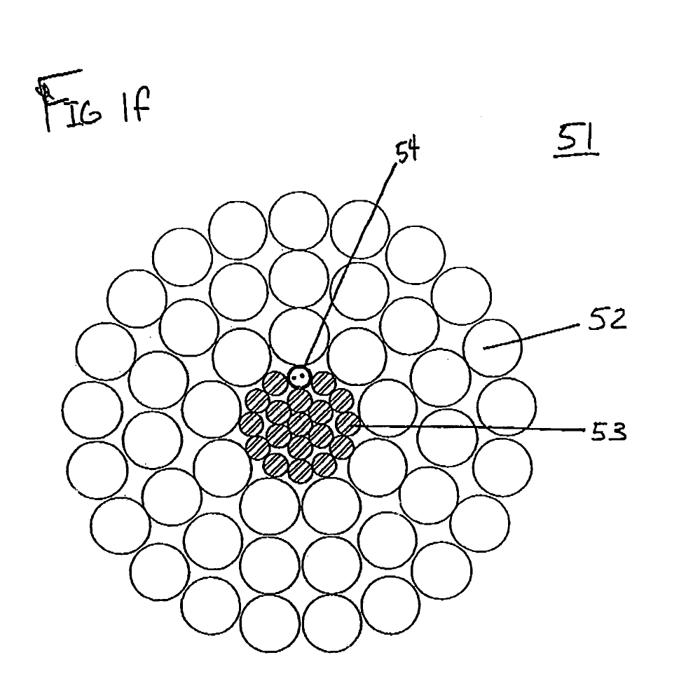

FIG. 1a depicts a schematic cross section of a core (1) of an electrical conductor or cable, which is formed from a plurality of reinforcing strands (2) and a plurality of conductive strands (3). The reinforcing strands (2) are located near the outer periphery of the core (1) and surround the conductive strands (3), which are located near the center of the core (1). A holding member (4) is located in the interstices (5) of the core (1) formed by the shape of the reinforcing strands (2) and/or the conductive strands (3), which both have a larger diameter than the holding member (4). The holding member (4) can be a protective device such as a tube having a circular cross section. Although the illustrated embodiment depicts one holding member (4) in an interstice (5), it is possible to have more than one holding member (4) in an interstice (5). The holding member (4) can potentially be located anywhere within the core (1) and can contain an optic fiber for temperature monitoring, communications, or a combination of both.

The holding member (4) surrounds at least one optical fiber (6). Because of the operating temperatures of the cable, it is preferable to use an optical fiber (6) that is heat resistant and can withstand high temperatures. For example, an optical fiber (6) with a polyimid coating could be used which allows operating temperatures up to 300° C. Alternatively, the optical fiber (6) can be made from heat resistant materials, such as quartz. Furthermore, the holding member (4) could also be gel-filled for to block water.

FIG. 1b depicts a schematic cross section of a core (11) of an electrical cable, which is formed from reinforcing strands (12) and conductive strands (13). Several holding members (14, 14¹, 14², and 14³) are located in the interstices (15, 15¹, 15², and 15³) of the core (11).

FIG. 1c depicts a cross section of a core (21) of a “bluejay” style of a cable having reinforcing strands (22) forming an outer periphery of the core (21) and conductive strands (23) located near the center of the core (21). For example, the center of the core (21) can be formed from six conductive strands (23) and one holding member (24) containing an optic fiber (26). The holding member (24) has approximately the same diameter as the individual conductive strands (23), which enables the holding member (24) to replace at least one of the conductive strands (23) in the core (21) of the cable without causing any structural deformities.

The illustrated embodiment does not suffer from ampacity loss, while only having approximately 5% strength loss. The location for temperature monitoring is good, but the location of the holding member (24) causes termination to be difficult.

FIG. 1d depicts a cross section of a core (31) of a “bluejay” style of a cable having reinforcing strands (32) forming an outer periphery of the core (31) and conductive strands (33) located near the center of the core (31). The holding member (34) has approximately the same diameter as one of the individual reinforcing strands (33), which enable the holding member (34) to replace a reinforcing strand (33). In the illustrated embodiment, the holding member (34) is located on the outer periphery of the cable (31) without causing any structural deformities and contains an optic fiber (36).

The illustrated embodiment has an ampacity loss of around 1% at 75° C., which may be expected in standard operating temperatures under the influence of sun and wind. This embodiment has a strength loss of approximately 1.5-2%. The location for temperature monitoring is bad because it is not near the conducting strands (33), but the location of the fiber optic conducting member (34) near the outer periphery of the core (31) causes termination to be easy.

FIG. 1e depicts a cross section of a core (41) of a “bluejay” style of a cable having reinforcing strands (42) forming an outer periphery of the core (41) and conductive strands (43) located near the center of the core (41). The holding member (44) has approximately the same diameter as one of the reinforcing strands (43), which enables the holding member (44) to replace a reinforcing strand (43) near the conductive strands (43). The holding member (44) contains an optic fiber (46).

The illustrated embodiment has an ampacity loss of around 1% at 75° C., which may be expected in standard operating temperatures under the influence of sun and wind. This embodiment has a strength loss of approximately 1.5-2% when compared to an unaltered core. The location for temperature monitoring is good because it is near the conducting strands (43), but the location of the fiber optic conducting member (44) near the conducting strands (43) causes termination to be difficult.

FIG. 1f depicts a cross section of a core (51) of a “45/19” ACSR style of a cable having reinforcing strands (52) forming an outer periphery of the core (51) and conductive strands (53) located near the center of the core (51). The holding member (54) has approximately the same diameter as the conductive strands (53), which enables the holding member (54) to replace a conductive strand (53) in the core (51) of the cable without causing any structural deformities.

This embodiment does not suffer from any ampacity loss, has around a 2% decrease in strength when compared to a normal cable. Termination of the embodiment is difficult, but the holding member (54) has a good location for measuring temperature.

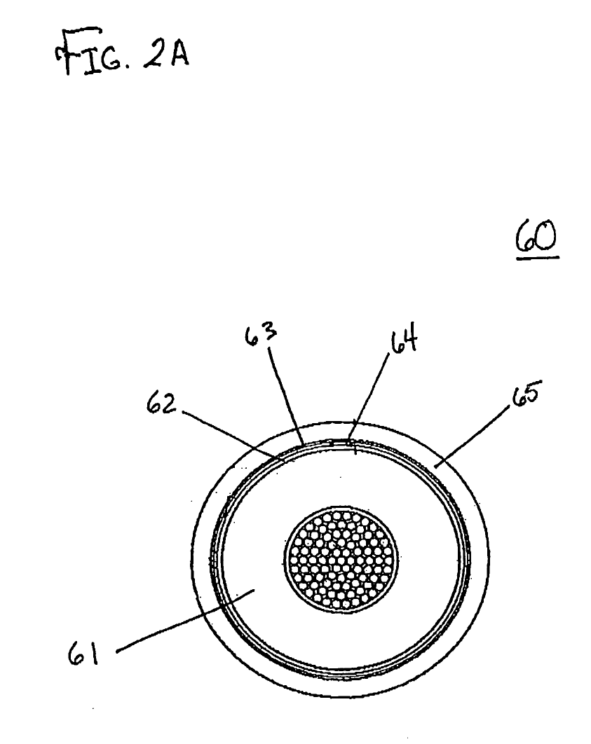

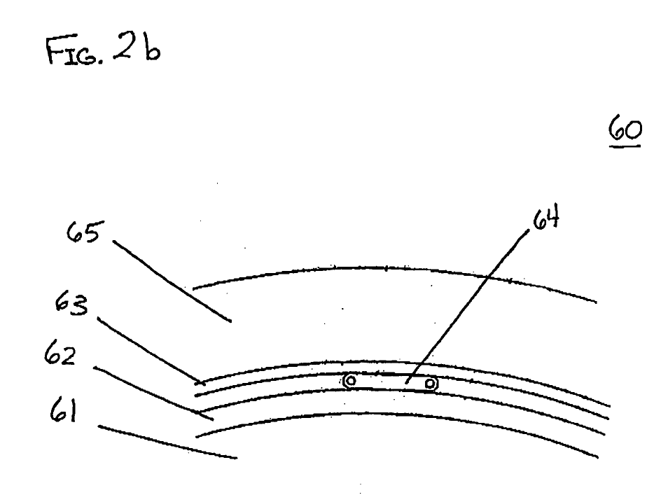

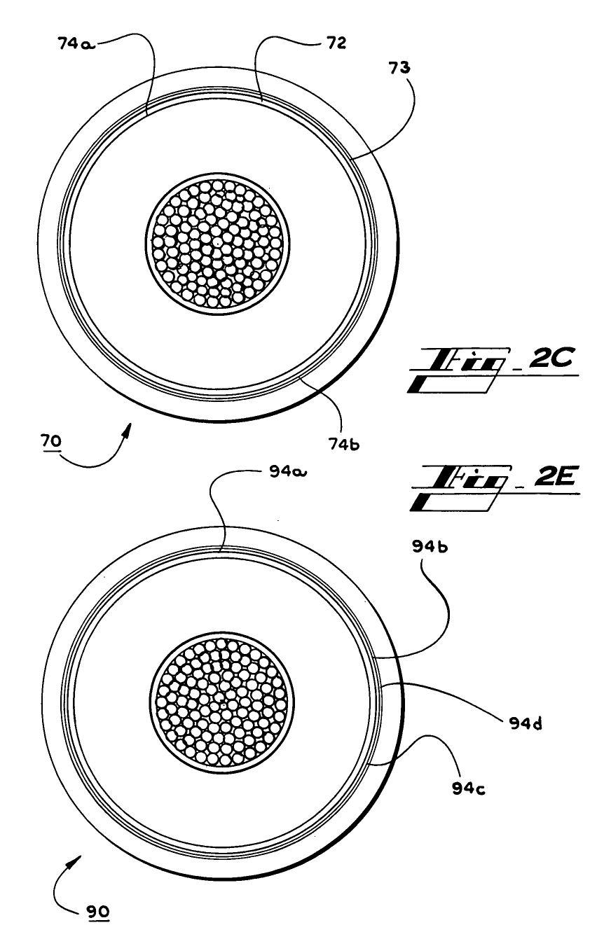

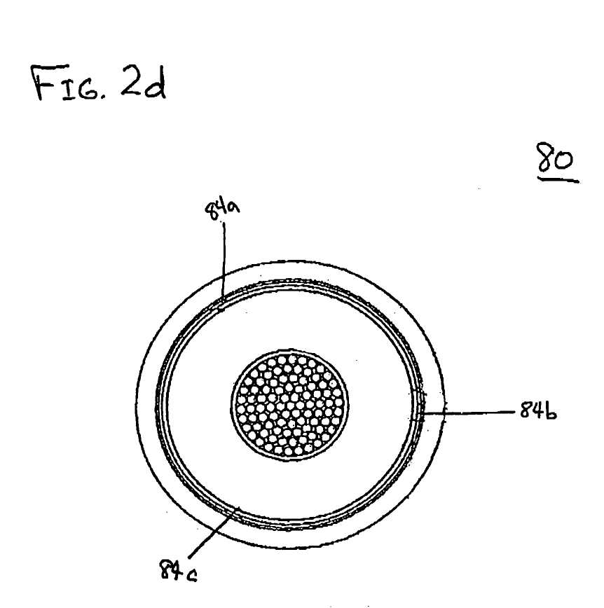

FIGS. 2a and 2b shows a cross section of a welded corrugate armor shield type high voltage conductor cable (60). FIG. 2a shows a whole cross section of the conductor cable (60), while FIG. 2b shows a partial cross-section of the conductor cable (60). The core (61) of the conductor cable (60) is covered by a layer of insulation/bedding tape (62). The layer of insulation/bedding tape (62) is completely or partially surrounded by a layer of corrugated welded armor (63). The corrugated welded armor is covered by a jacket (65). One holding member (64) is located in between the layer of insulation/bedding tape and the corrugated welded armor (63). The holding member (64) has an oval cross section shape. The holding member can be placed in the conductor cable (60) in a longitudinal fashion or a helically wrapped around the core (61). The holding member (64) can be held in place by a binder string, tape, or other connective means.

The elongated oval shape of the holding member (64) imparts crush resistance and distributes pressure. If the holding member (64) is crushed, then the optic fiber (66) within may be damaged and rendered useless. Furthermore, the oval shape distributes pressure so that there is less indentation of the insulation/bedding tape (62), which maintains the integrity of the layer of insulation/bedding tape (62).

The holding member (64) can be made from a variety of materials such as metals, composites, plastics, and/or a combination thereof. For example, the holding member (64) can be made of stainless steel or a combination of stainless steel and dielectric plastic.

FIG. 2c illustrates an embodiment of the welded corrugate armor shield type high voltage conductor cable (70) having two holding members (74a and 74b) located approximately opposite of each other. The second holding member (74b) can be located in between the layer of tape (72) and the armor (73) or can be located elsewhere in the cable (70).

FIG. 2d details another embodiment of the welded corrugate armor shield type high voltage conductor cable (80) having three holding members (84a, 84b, and 84c) that are approximately equidistant from each other forming a triangular shape in cross section. The three holding members (84a, 84b, and 84c) can have similar or different arrangements in the cable (80).

FIG. 2e depicts an alternative embodiment of the welded corrugate armor shield type high voltage conductor cable (90) having four holding members (94a, 94b, 94c, and 94d). This depicted embodiment also shows an equidistant relationship between the holding members (94a, 94b, 94c, and 94d), which results in a diamond shape in cross section. The holding members (94a, 94b, 94c, and 94d) can be arranged between similar or different components of the cable (90).

The equidistant relationship illustrated in FIGS. 2c-2e is not controlling and other arrangements are possible.

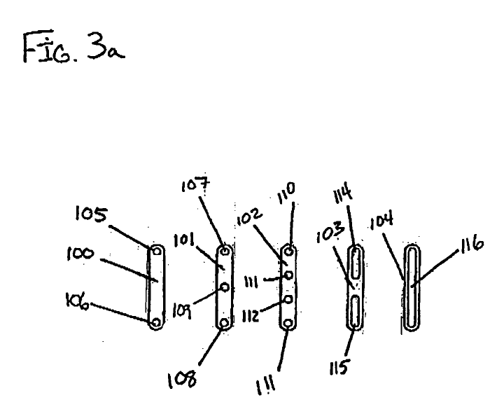

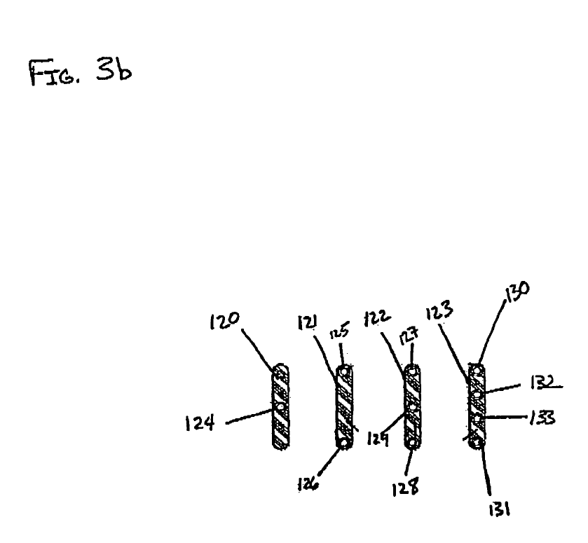

FIG. 3a illustrates first, second, third, fourth, and fifth cross sections of various holding members (100, 101, 102, 103, and 104), which can have variable sizes, opening sizes, and wall thickness.

The first cross section of the holding member (100) has a width that is more than two times its height. The first cross section of the holding member is shaped so as to have two circular openings (105, and 106) on opposite ends of the holding member (100). The first cross section of the holding member (100) has a width that is more than twice the height of the holding member (100). The circular openings (105, and 106) are located approximately an equal distance from the sides of the holding member (100) and so that an imaginary line could be formed that passes through the diameters of the circular openings (105, and 106). Such a construction allows the holding member (100) to separate at least two fiber optic cables or at least two bundles of fiber optic cables (not shown).

The second cross section of the holding member (101) has a shape forming three circular openings (107, 108, and 109). Two of the circular openings (107, and 108) are located near opposite ends of the holding member (101), while the third circular opening (109) is located near the center of the holding member (101). The distance between the third circular opening (109) and the circular openings (107, and 108) located near the ends of the holding member (101) are approximately equal in distance. Such a construction allows the holding member (101) to separate three fiber optic cables or three bundles of fiber optic cables (not shown).

The third cross section of the holding member (102) has a shape forming four circular openings (110, 111, 112, and 113). To of the circular openings (110, and 111) are located towards the ends of the holding member (102), while the other two circular openings (111, and 112) are located in between circular openings (110, and 111) located towards the ends of the holding member (102). Such a construction allows the holding member (102) to separate four fiber optic cables or four bundles of fiber optic cables (not shown).

The fourth cross section of the holding member (103) has a shape forming two oval openings (114, and 115) on opposite ends of the holding member (103). The oval openings (114, and 115) are located approximately an equal distance from the sides of the holding member (103) and so that an imaginary line could be drawn that passes through an equal amount of each oval opening (114, and 115). Such a construction allows the holding member (103) to separate at least two fiber optic cables or at least two bundles of fiber optic cables (not shown).

The fifth cross section of the holding member (104) has a shape forming one oval opening (116) that is proportionate to the overall cross section of the holding member (104). The oval opening (116) allows the holding member (104) to hold at least one fiber optic cables or at least one bundle of fiber optic cables.

The aforementioned first, second, third, fourth, and fifth cross section (100, 101, 102, 103, and 104) shown in FIG. 3a are formed from stainless steel in the depicted embodiments. One skilled in the art would recognize that a variety of materials could be utilized, such as other metals, plastics, composites, and the like.

FIG. 3b depicts additional cross sections of holding members (120, 121, 122, and 123).

The first illustrated cross section of the holding member (120) is oval shaped and formed from a dielectric plastic, composite, or stainless steel. The holding member (120) supports a tube (124) formed from another material, such as stainless steel, composite, or plastic. The tube (124) can be made from the same or different material from the holding member (120). The tube (124) in the depicted embodiment is located at an equal distance from the ends of the holding member (120). However, the tube (124) could be located anywhere within the holding member (120). The single tube (124) allows at least one fiber optic cables or at least one bundle of fiber optic cables (not shown) to be placed in the holding member (120).

The second cross section of the holding member (121) is oval shaped and formed from a dielectric plastic, composite, or stainless steel. The holding member (121) supports two tubes (125 and 126) located on opposite ends of the holding member (121). The tubes (125, and 126) can be made from the same or different material from the holding member (121). The tubes (125, and 126) are located approximately an equal distance from the sides of the holding member (121) and so that an imaginary line could be formed that passes through the diameters of the tubes (125, and 126). Such a construction allows the holding member (121) to separate at least two fiber optic cables or at least two bundles of fiber optic cables (not shown).

The third cross section of the holding member (122) is oval shaped and formed from a dielectric plastic, composite, or stainless steel. The holding member (122) supports three tubes (127, 128, and 129). Two tubes (127, and 128) are located on opposite ends of the holding member (122). The third tube (129) is located in between the two tubes (127, and 128) located on opposite ends of the holding member (122). The tubes (127, 128, and 129) can be made from the same or different material from the holding member (122). Likewise, the tubes (127, 128, and 129) can be made from different materials in respect to each other. The tubes (127, and 128) are located approximately an equal distance from the sides of the holding member (122) and an imaginary line could be drawn that passes through the diameters of the tubes (127, 128, and 129). Such a construction allows the holding member (122) to separate three fiber optic cables or three bundles of fiber optic cables (not shown).

The fourth cross section of the holding member (123) is oval shaped and formed from dielectric plastic, composite, or stainless steel. The holding member (123) supports four tubes (130, 131, 132, and 133). Two tubes (130, and 131) are located on opposite ends of the holding member (123). Two inner tubes (132, and 133) are located in between the two tubes (130, and 131) located on opposite ends of the holding member (123). The tubes (130, 131, 132, and 133) can be made from the same or different materials than the holding member (123). Likewise, the tubes (130, 131, 132, and 133) can be made from different materials in respect to each other. The tubes (130, 131, 132, and 133) are equally spaced and an imaginary line could be drawn that passes through the diameters of the tubes (130, 131, 132, and 133). Such a construction allows the holding member (123) to separate four fiber optic cables or three bundles of fiber optic cables.

FIG. 4 depicts an embodiment of the welded corrugate armor shield type high voltage conductor cable (140) wherein the holding member (144) is arranged longitudinally in the jacket material (145) on the exterior of the corrugated welded armor (143). This arrangement avoids twisting of the optical fibers (not shown) contained in the holding member (144). This arrangement is possible with either a core/neutral wire assembly or a core/welded assembly. The holding member (144) is arranged longitudinally on the cable (140) and then the jacket material (145) is extruded on the assembly to effectively embed the holding member (144) into the jacket material (145).

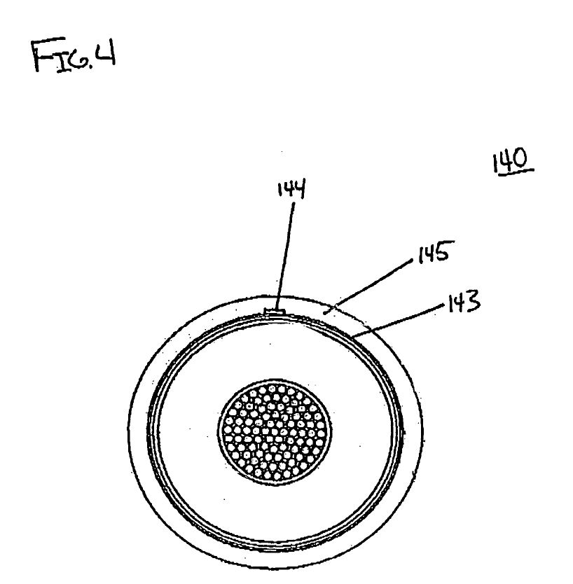

FIG. 5 depicts an embodiment where a conductor cable (150) has a core (151) surrounded by a insulation/bedding tape (152). Concentric stranded neutrals (156) are placed on top of the insulation/bedding tape (152) and surrounded by jacket material (155). A holding member (154) is embedded in the jacket material (155).

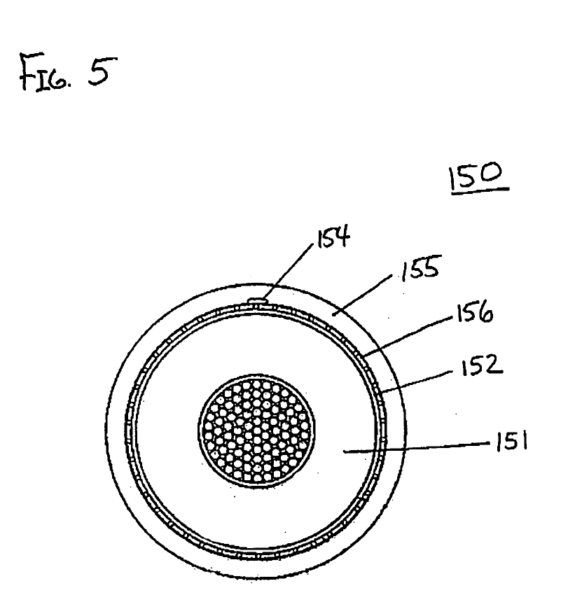

FIG. 6 illustrates another embodiment wherein the holding member (164) is placed in between the core (161) of the conductor cable (160) and the layer of insulation/bedding tape (162). Concentric stranded neutrals (166) are placed over the layer of insulation/bedding tape (162). A jacket (165) is formed on the concentric stranded neutrals (166).

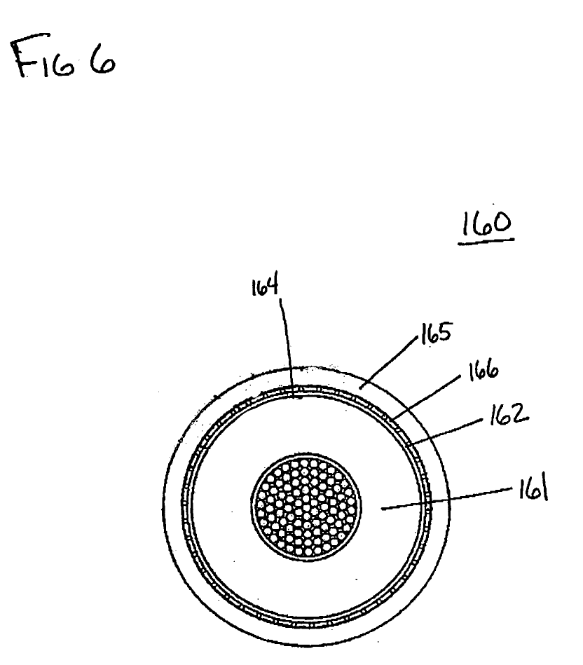

FIG. 7 illustrates an embodiment of the electrical conductor cable (170), wherein the core (171) is surrounded by a layer of insulating/bedding tape (172). Concentric stranded neutrals (176) are then placed on the exterior side of the tape (172). A holding member (174) replaces one of the concentric stranded neutrals (176). The concentric stranded neutrals (176) are then surrounded by water swellable tape (177) that is longitudinally or cigarette wrapped around the neutrals (176). A jacket (175) is formed on the exterior side of the water swellable tape (177).

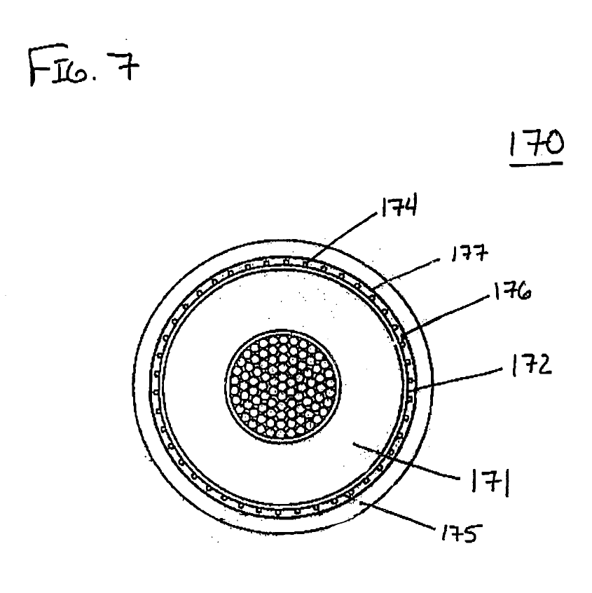

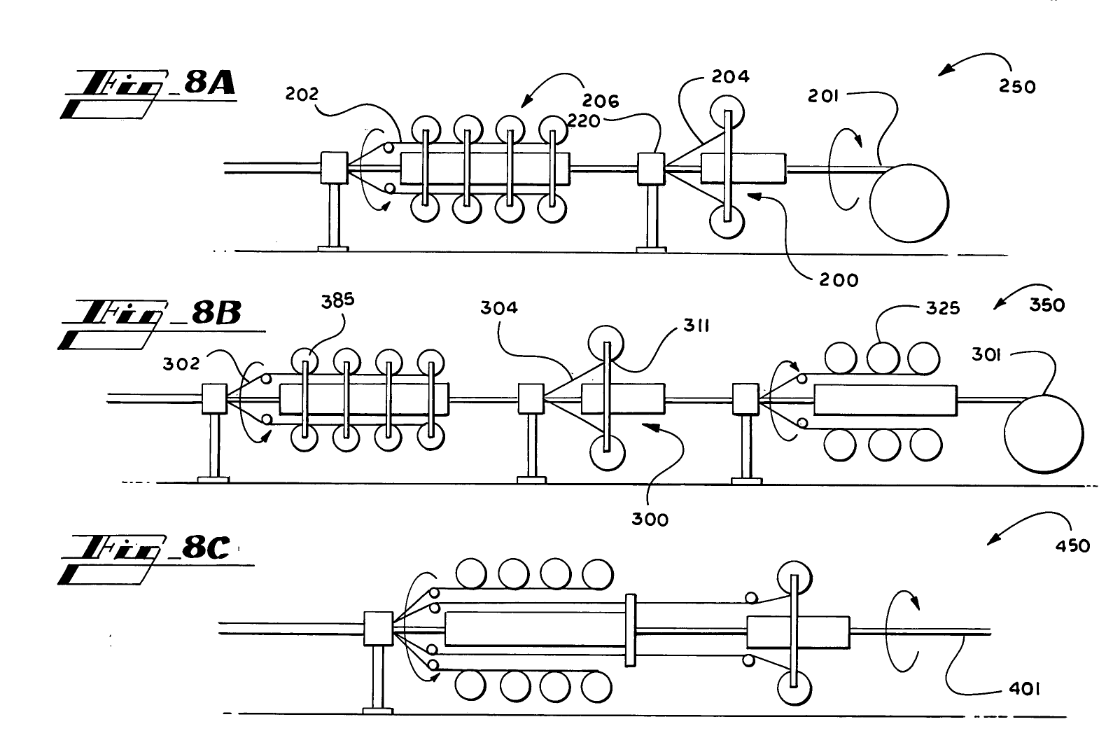

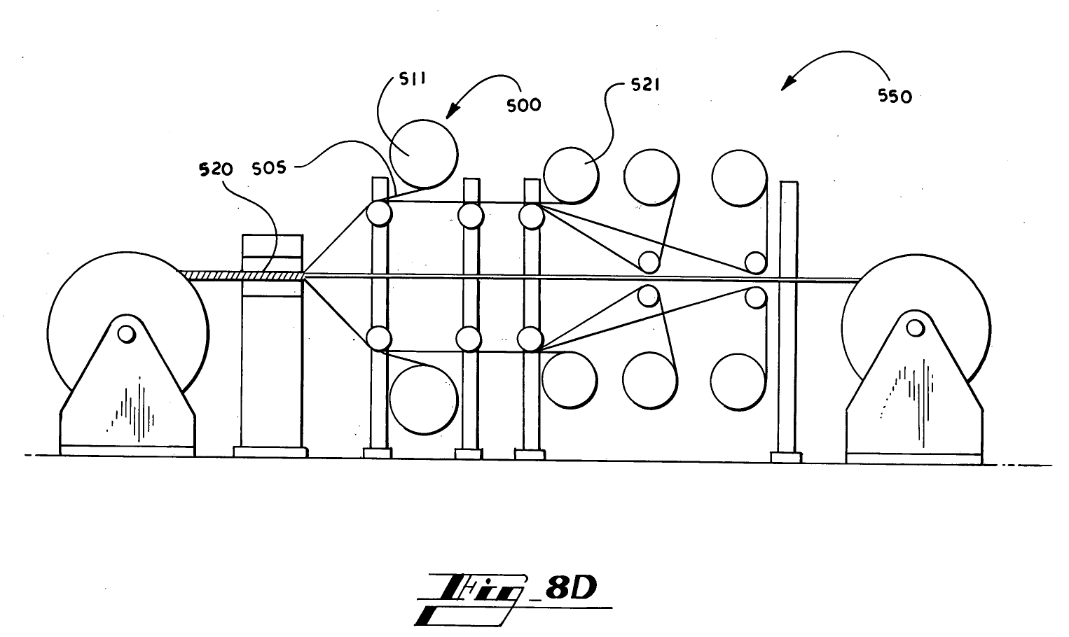

FIG. 8a relates to a method of manufacturing the present invention with a planetary strander device (200), which forms a part of a wire assembly apparatus (250).

A prestranded core strand (201) is fed into the strander device (200) in the direction of the arrow. A holding member (204) is then placed onto the core strand (201) and passes through a compression die (220). The holding member (204) and core strand (201) are subsequently covered by additional strands (202). This allows the holding member to be located near the center of the cable.

For placing the holding member (204) under the layer of the additional strands (202), the device (200) has a sensor (210) that directs a planetary flyer (211) to rotate in unison with the spiral configuration of the core strand (201) passing through the strander device (200). This could be done by sensing the passage of the core (201) and counting the passage of strands, human or computer input to the device (200) would tell it how many strands were in the outer layer of the core (201) thus generating a signal to rotate the planetary flyer (211) in unison with the lay of the outer layer of the core (201).

After the core strand (201) is stranded with the holding member (204), it passes through a downstream conventional rigid frame strander (206) that places additional strands (202) onto the core (201) and holding member (204).

FIG. 8b depicts a second wire assembly apparatus (350), which is similar to the wire assembly apparatus (250) shown in FIG. 8a.

A core strand (301) is formed and then fed into the planetary strander device (300). A holding member (304) is then placed onto the core strand (301). The holding member (304) and core strand (301) are subsequently covered by additional strands (302).

The second wire assembly apparatus (350) creates a core strand (301) that is then stranded with a holding member (304). The planetary stranding device (300) has a sensor that senses the rotation of the up-stream flyer (325) and rotates the planetary flyer (311) in unison with the up-stream flyer (325) placing at least one holding member (304) on top of the core strand (301). The core strand (301) and the holding member (304) are then passed through a compression die (320) and eventually covered by additional strands (302) of the down-stream flyer (335).

FIG. 8c depicts a third wire assembly apparatus (450). A core strand (401) can be fed into the apparatus (450). The holding member is placed (404) into the layer of additional strands (402) that are placed on the core strand (401). This allows the holding member (404) to be near the outer periphery of the cable.

A holding member (404) is placed on a core strand (401) without passing through a compression die (420) and subsequently additional strands (402) are placed on the holding member (404) and the core strand (401).

The third wire assembly apparatus (450) has a planetary stranding device (400) which is controlled by a sensor (410) that initiates rotation of the planetary flyer (411) in unison with the rotation of the down-stream flyer (406) to placing the holding member (404) on the same spiral lay of additional strands (402) being placed by the down-stream flyer (421).

FIG. 8d depicts another wire assembly apparatus (550) which places the holding member (505) into an interstice (not shown). The planetary strander device (500) is designed to hold one or more holding members (505) that are to be placed in the particular layer of the cable. For placing the holding member (505) into a layer or into the interstices of the strands of a layer, the device (500) would have a signal sensing drive or direct mechanical drive that matches the rotation of the device's planetary flyer (511) with the rotation of the flyer (521) applying the additional strands (502). Applying the holding member (505) and the additional strands (502) to the core strand (501). The holding member (505) and additional strands (502) pass through a common closing block (520).

Further variations and modifications of the foregoing will be apparent to those skilled in the art and are intended to be encompassed by the claims appended hereto.

1. An electrical cable comprising:
conducting strands;
reinforcing strands surrounding the conducting strands and located near the outer periphery thereof; and
a holding member containing a temperature sensing means located in an interstice of the electrical cable.

2. The electrical cable of claim 1, wherein the holding member is located in an interstice formed by the reinforcing strands.

3. The electrical cable of claim 1, wherein the holding member is located in an interstice formed by the conducting strands.

4. The electrical cable of claim 1, wherein the holding member is located in an interstice formed by the reinforcing strands and conducting strands.

5. An electrical cable comprising:
strands forming a core of the cable; and
a holding member containing a temperature sensing means, wherein the holding member replaces at least one of the strands.

6. The electrical cable of claim 5, wherein the strands are comprised of reinforcing strands located near the outer periphery of the core and conducting strands that are surrounded by the reinforcing strands; and wherein the holding member replaces at least one of the reinforcing strands.

7. The cable of claim 6, wherein the holding member replaces at least one of the reinforcing strands near the conducting strands.

8. (canceled)

9. The cable of claim 6, further comprising a second holding member that replaces at least one of the conducting strands.

10. The conductor of claim 5, wherein the optic fiber is heat resistant.

11-25. (canceled)
